(19) United States
(12) Patent Application Publication
(10) Pub. No.: US 2019/0153225 A1
(43) Pub. Date: May 23, 2019

(54) POLYIMIDE COMPOSITION HAVING A LOW COEFFICIENT OF THERMAL EXPANSION

(71) Applicant: ROGERS CORPORATION, Chandler, AZ (US)

(72) Inventors: Karl Edward Sprentall, Scottsdale, AZ (US); Trevor Polidore, Somerville, MA (US); Murali Sethumadhavan, Acton, MA (US)

(21) Appl. No.: 16/193,339

(22) Filed: Nov. 16, 2018

Related U.S. Application Data
(60) Provisional application No. 62/609,660, filed on Dec. 22, 2017.
(60) Provisional application No. 62/587,605, filed on Nov. 17, 2017.

(51) Int. Cl. C08L 79/08; C08J 5/18

(52) U.S. Cl. CPC C08L 79/08; C08J 5/18; C08J 2427/18; C08L 2203/16; C08J 2379/08; C08L 2205/03

(57) ABSTRACT

A polyimide composition that includes a polyimide having a linear coefficient of thermal expansion of less than or equal to 1 ppm/° C., or −0.5 to 0.5 ppm/° C.; and a fluoropolymer; wherein the polyimide composition has a permittivity of less than or equal to 5, or less than or equal to 3.5 at a frequency of 10 GHz.

### CROSS-REFERENCE TO RELATED APPLICATIONS

This application claims the benefit of U.S. Provisional Patent Application Ser. No. 62/587,605 filed Nov. 17, 2017 and U.S. Provisional Patent Application Ser. No. 62/609,660 filed Dec. 22, 2017. The related applications are incorporated herein in their entirety by reference.

### BACKGROUND

In the electronics industry, polyimide compositions are often used in coating applications and as dielectric layers due to their low dielectric constant, low stress, high modulus, and inherent ductility. The polyimide layers are therefore often in physical and thermal contact with one or more layers. During the manufacture and use of devices comprising such multilayer components, the devices can experience significant heating and cooling cycles. As a result, the multilayers can experience multiple cycles of heating and cooling, often covering temperature ranges of 350 degrees Celsius (° C.) or more during manufacturing. The heating and cooling cycles generate stresses as a result of differences in coefficient of thermal expansion (CTE) values and other variables between the different layers. These stresses can result in deformation, delamination, and/or cracks, which can degrade the performance of the device and/or lead to premature failure.

In certain applications, it is desirable to control the CTE of the polyimides so that the value of the polyimide CTE is matched as closely as possible to the value of the substrate CTE used in the device. The similar values of the CTE of the polyimide and adjacent or nearby components can mitigate thermal stresses associated with thermal cycling, for example, in polyimide compositions used as the dielectric in copper clad laminates. These polyimide compositions comprise a glass fabric to help control the thermo-mechanical properties of the polyimide layer to match the CTE of copper. Limitations for such dielectric layers arise due to issues with thickness limitations, flowability of the polyimide onto the glass fabric, and due to the microscopic differences in the dielectric properties across the plane of the dielectric layer.

An improved polyimide layer that is free of a glass fabric is therefore desired as such a layer could result in significant benefits for use in electronics applications.

### SUMMARY

Disclosed herein is a polyimide composition.

In an aspect, the polyimide composition comprises a polyimide having a linear CTE of less than or equal to 1 ppm/° C., or −0.5 to 0.5 ppm/° C.; and a fluoropolymer; wherein the polyimide composition can have a permittivity of less than or equal to 5, or less than or equal to 3.5 at a frequency of 10 GHz.

Also disclosed herein is a method of making the polyimide composition that comprises forming a combination comprising a poly(amic acid), the fluoropolymer, a solvent, and optionally a nonionic surfactant; casting the combination; and heating the cast combination to evaporate the solvent and to form the polyimide from the poly(amic acid). The polyimide composition comprising a polyimide having a linear CTE of less than or equal to 1 ppm/° C., or −0.5 to 0.5 ppm/° C.; and a fluoropolymer; wherein the polyimide composition can have a permittivity of less than or equal to 5, or less than or equal to 3.5 at a frequency of 10 GHz.

Disclosed herein is also an article comprising the polyimide composition comprising a polyimide having a linear CTE of less than or equal to 1 ppm/° C., or −0.5 to 0.5 ppm/° C.; and a fluoropolymer; wherein the polyimide composition can have a permittivity of less than or equal to 5, or less than or equal to 3.5 at a frequency of 10 GHz.

The above described and other features are exemplified by the following detailed description and claims.

### DETAILED DESCRIPTION

It was surprisingly discovered that a polyimide composition comprising a polyimide having a linear CTE of less than or equal to 1 parts per million per degree Celsius (ppm/° C.) and a fluoropolymer could result in a polyimide composition having a permittivity of less than or equal to 5, or less than or equal to 3.5 at a frequency of 10 gigahertz (GHz). This result is especially surprising because the polyimide composition having this low permittivity is achieved in the absence of a glass fabric. As used herein, the linear CTE can be determined in accordance with ASTM E831-06 or ASTM D3386-00 over a range of −125 to 20° C., or over a range of 0 to 20° C. using a 1 mil (0.0254 millimeter) thick sample. For example, the linear CTE of a sample consisting essentially of the polyimide can be determined in accordance with ASTM E831-06 and the linear CTE of the polyimide composition can be determined in accordance with ASTM D3386-00.

The polyimide composition can comprise 40 to 80 volume percent (vol %), or 40 to 70 vol % of the polyimide based on the total volume of the polyimide and the fluoropolymer. The polyimide composition can comprise 20 to 60 vol %, or 30 to 60 vol % of the fluoropolymer based on the total volume of the polyimide and the fluoropolymer. The polyimide composition can comprise a thermoset polyimide, but a thermoplastic polyimide is preferred.

The polyimide composition can be formed by forming a combination comprising a poly(amic acid), a fluoropolymer, a solvent, and a surfactant; casting the combination; and heating the cast combination to evaporate the solvent and to form the polyimide from the poly(amic acid). The combination can be cast into a film on a substrate, for example, by solvent casting, spin casting, gravure coating, three roll coating, knife over roll coating, slot die extrusion, or dip coating. After casting, the combination can be heated in one or more stages to remove solvent and convert the amic acid functional groups in the poly(amic acid) to imides via a cyclodehydration reaction, also called imidization. The heating can occur under vacuum to promote one or both of evaporation of the solvent and of the water by-product during the imidization reaction.

The heating can occur in two or more heating stages. For example, the heating can comprise a first evaporation stage to evaporate the solvent. The first evaporation stage can occur at an evaporation temperature of 23 to 100° C. The heating can comprise a second heating stage that occurs after the first heating stage to initiate the cyclodehydration reaction that can occur at a curing temperature of greater than or equal to 150° C., or 200 to 350° C., or 250 to 310° C.

Water can be removed during the cyclodehydration reaction, for example, by evaporation with or without vacuum or by chemically removing the water. Chemical removal of the water can include reaction with at least one of dicyclohexylcarbodiimide or an anhydride, for example, acetic anhydride. An imidization catalyst can be used to facilitate the cyclodehydration reaction. The imidization catalyst can comprise a tertiary amine, for example, at least one of pyridine, triethyl amine, isoquinoline, or beta-picoline.

The poly(amic acid) can be derived from a monomer composition comprising at least a diamine monomer and a dianhydride monomer. The polymerization of the poly(amic acid) can occur in the presence of a polar, aprotic solvent. The polar, aprotic solvent can comprise at least one of N-Methyl-2-pyrrolidone (NMP) or N,N-dimethylacetamide (DMAC). The polymerization can occur at a temperature of less than or equal to 70° C., or 10 to 70° C., or 20 to 30° C. A molar ratio of the diamine to the dianhydride can be 2:1 to 1:2, or 1.5:1 to 1:1.5, or 1.1:1 to 1:1.1.

The diamine monomer can comprise at least one of 1-(4-aminophenoxy)-3-(3-aminophenoxy)benzene, 1-(4-aminophenoxy)-4-(3-aminophenoxy)benzene, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 2,2-bis[4-(4-aminophenoxy)phenyl]hexafluoropropane (BDAF), bis[4-(4-aminophenoxy)phenyl]sulfone, 2,2-bis[4-(3-aminophenoxy)phenyl]sulfone, 4-aminophenyl-3-aminobenzoate, N,N-bis(4-aminophenyl)aniline, N,N-bis(4-aminophenyl)-n-butylamine, bis(3-aminophenyl)diethyl silane, 2,2-bis(3-aminophenyl)-1,1,1,3,3,3-hexafluoropropane, bis(4-[4-aminophenoxy]phenyl)ether, 2,2-bis[4-(4-aminophenoxy)phenyl]-hexafluoropropane, 2,2′-bis(4-aminophenyl)-hexafluoropropane (6F-diamine), N,N-bis(4-aminophenyl)methylamine, 2,2-bis(4-aminophenyl)propane, bis(p-beta-amino-t-butylphenyl)ether, benzidine, 1,4-cyclohexyldiamine (CHDA), diaminobenzanilide, 1,2-diaminobenzene, 3,5-diaminobenzoic acid, 4,4′-diaminobenzophenone, 1,4-diaminobutane, 1,10-diaminodecane, 4,4′-diaminodiphenyl diethyl silane, 3,4′-diaminodiphenyl ether, 4,4′-diaminodiphenyl ether, 4,4′-diaminodiphenyl ether phosphine oxide, 4,4′-diaminodiphenyl methane, 4,4′-diaminodiphenyl N-methyl amine, 4,4′-diaminodiphenyl N-phenyl amine, 4,4′-diaminodiphenyl propane, 4,4′-diaminodiphenyl sulfide, 3,3′-diaminodiphenyl sulfone, 4,4′-diaminodiphenyl sulfone, 1,4-diaminobutane, diaminodurene (DMDE), 1,2-diaminoethane, 1,7-diaminoheptane, 1,6-diaminohexane, 1,5-diaminonaphthalene, 1,9-diaminononane, 1,8-diaminooctane, 1,5-diaminopentane, 1,3-diaminopropane, 2,6-diaminopyridine, 3,3′-dichlorobenzidine, 3,3′-dimethoxybenzidine, p-bis(1,1-dimethyl-5-aminopentyl)benzene, 3,3′-dimethyl-4,4′-diaminobiphenyl, 4,4′-isopropylidenedianiline, p-bis-2-(2-methyl-4-aminopentyl)benzene, 4,4′-methylenebisbenzeneamine, 4,4′-methylenebis(cyclohexylamine) (MBCHA), 4,4′-methylenebis(2-methylcyclohexylamine), 3,3′-oxydianiline, 3,4′-oxydianiline, 4,4′-oxydianiline, 2,2′-bis(4-phenoxyaniline)isopropylidene, m-phenylenediamine, o-phenylenediamine, p-phenylenediamine, m-xylenediamine, p-xylenediamine, an amino-terminal polydimethylsiloxane, an amino-terminal polypropyleneoxide, or an amino-terminal polybutylene oxides.

The dianhydride can comprise at least one of benzene-1,2,3,4-tetracarboxylic dianhydride, benzene-1,2,4,5-tetracarboxylic dianhydride (pyromellitic dianhydride) (PMDA), 2,3,2′,3′-benzophenone tetracarboxylic dianhydride, 3,3′,4,4′-benzophenone tetracarboxylic dianhydride, 3,3′,4,4′-biphenyl sulfone tetracarboxylic dianhydride, 2,2′,3,3′-biphenyl tetracarboxylic dianhydride, 3,3′,4,4′-biphenyl tetracarboxylic dianhydride, 2,2-bis(3,4-dicarboxyphenyl)hexafluoropropane, bis(3,4-dicarboxyphenyl)methane dianhydride, 2,2-bis(3,4-dicarboxyphenyl)propane dianhydride, bis(3,4-dicarboxyphenyl)sulfide dianhydride, bis(3,4-dicarboxyphenyl)sulfoxide dianhydride, 2,6-dichloronaphthalene-1,4,5,8-tetracarboxylic dianhydride, 2,7-dichloronaphthalene-1,4,5,8-tetracarboxylic dianhydride, 3,3′,4,4′-diphenylsulfone tetracarboxylic dianhydride, 4,4′-(hexafluoroisopropylidene)diphthalic anhydride, hydroquinone dianhydride, 4,4′-(4,4′-isopropylidenediphenoxy)bis(phthalic anhydride), naphthalene-1,4,5,8-tetracarboxylic dianhydride, naphthalene-2,3,6,7-tetracarboxylic dianhydride, 4,4′-oxydiphthalic anhydride (ODPA), 4,4′-oxydiphthalic dianhydride, 3,4,9,10-perylene tetracarboxylic dianhydride, phenanthrene-8,9,10-tetracarboxylic dianhydride, pyrazine-2,3,5,6-tetracarboxylic dianhydride, pyromellitic dianhydride, 2,3,6,7-tetrachloronaphthalene-1,4,5,8-tetracarboxylic dianhydride, thiophene-2,3,4,5-tetracarboxylic dianhydride, or a polysiloxane-containing dianhydride.

The poly(amic acid) can be derived from a diamine and a dianhydride that is one or both of linear (for example, para substituted) and more rigid (for example, comprising arylene rings), as both increasing the linearity of the polymer backbone and decreasing its flexibility can result in a lower CTE of the resultant polyimide. For example, the diamine can comprise a para-substituted diamine (for example, p-phenylene diamine (p-PDA)) and the dianhydride can comprise a para-substituted dianhydride (for example, at least one of 3,3′,4,4′-biphenyltetracarboxylic dianhydride (symmetric BPDA or s-BPDA) or pyromellitic dianhydride). The dianhydride can comprise s-BPDA and the diamine can comprise p-PDA. The dianhydride can comprise pyromellitic dianhydride and the diamine can comprise 2,2′-dimethylbenzidine (DMB).

In addition to reducing the coefficient of thermal expansion, incorporation of one or more of these linear and/or rigid monomers can also result in a reduction in the coefficient of hydroscopic expansion (CHE). The coefficient of hydroscopic expansion is a measurement of the dimensional change in response to a given change in the environmental relative humidity. The coefficient of hydroscopic expansion can also be reduced by the incorporation of hydrophobic repeat units, for example, that comprise one or more fluorinated groups. Examples of fluorinated monomers include 2,2-bis[4-(4-aminophenoxy)phenyl]hexafluoropropane (BDAF), 2,2-bis(3-aminophenyl)-1,1,1,3,3,3-hexafluoropropane, 2,2-bis[4-(4-aminophenoxy)phenyl]-hexafluoropropane, 2,2′-bis(4-aminophenyl)-hexafluoropropane (6F-diamine), 4,4′-(hexafluoroisopropylidene)diphthalic anhydride, and 2,2-bis(3,4-dicarboxyphenyl)hexafluoropropane.

The polymerization of the poly(amic acid) can comprise polymerizing in the presence of a crosslinker. The crosslinker can comprise a poly(C₂₋₂₀ alkylene-alt-maleic anhydride) (for example, at least one of poly(ethylene-alt-maleic anhydride), poly(maleic anhydride-alt-1-octadecene), or poly(isobutylene-alt-maleic anhydride). The polyimide can comprise at least one oxygenated hydrocarbon cross-linking the polyimide. The oxygenated hydrocarbon can comprise at least one of acrolein, benzaldehyde, butylaldehyde, cinnamaldehyde, crotonaldehyde, diacyloxymethane, di(C₁₋₆ alkoxy)methane, 1,3-dioxane, dioxolane, 1,3-dithiane, glyoxal, formaldehyde, furfural, glycidyl ether iso-butylaldehyde, laurinaldehyde, methylal, naphthaldehyde, 1,3-oxathianeacetaldehyde, paraformaldehyde, propionaldehyde, salicylaldehyde, stearinaldehyde, succindialdehyde, tetraoxane, tolylaldehyde, trioxane, or valeraldehyde. The oxygenated hydrocarbon can comprise at least one of paraformaldehyde, formaldehyde, dioxolane, or trioxane.

The polymerization of the poly(amic acid) can comprise adding an endcapper. The endcapper can be introduced after the reaction between the diamine and the dianhydride has reached completion, for example, after 24 hours. The endcapper can comprise at least one of a monofunctional amine or a monofunctional anhydride. The endcapper can comprise a monofunctional anhydride that is added to react with amine endgroups. The endcapper can comprise a crosslinkable monoanhydride.

The polyimide can comprise a bulky substituent. In general, bulky substituents are moieties that tend to interfere with intramolecular and intermolecular chain association because of their size. The bulky substituent can be part of the polyimide backbone, e.g., covalently bonded between phenyl groups in the polymer backbone. Alternatively, or in addition, the bulky substituents can be covalently bonded to a group of the polymer backbone, via a tether (i.e., a linking group such as an alkyl group or other substituent) or via a direct bond to the polyimide backbone (e.g., bonded directly to a phenyl group of the polymer backbone). It is also possible for the bulky substituents to be associated with the polymer via ionic bonds, hydrogen bonds, or other attractions. In an aspect, the bulky groups can be dispersed through the polyimide composition, and can have essentially no chemical interaction between a bulky substituent and the polyimide. A combination of the foregoing interactions can also be used. The incorporation of a bulky substituent into a more flexible polyimide composition can result in a decrease in segmental mobility of the polyimide and can result in reduction of the CTE of the polyimide.

The bulky substituent can comprise a polyhedral oligomeric silsesquioxane (commonly referred to as “POSS,” also referred to herein as the “silsesquioxane”). The incorporation of a silsesquioxane can have the added benefit of improving the durability of the polyimide in oxidizing environments. The silsesquioxane is a nano-sized inorganic material with a silica core that can have reactive functional groups on the surface. The silsesquioxane can have a cube or a cube-like structure comprising silicon atoms at the vertices and interconnecting oxygen atoms. Each of the silicon atoms can be covalently bonded to a pendent R group. The silsesquioxane of the formula (I) (R₈Si₈O₁₂) comprises a cage of silicon and oxygen atoms around a core with eight pendent R groups.

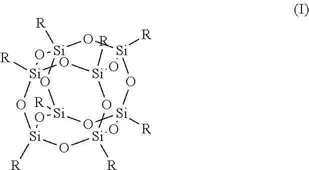

Each R group independently can be a hydrogen, a hydroxy group, an alkyl group, an aryl group, or an alkenyl group, where the R group can comprise one to twelve carbon atoms and one or more heteroatoms (for example, at least one of oxygen, nitrogen, phosphorus, silicon, or a halogen). Each R group independently can comprise a reactive group such as at least one of an alcohol, an epoxy group, an ester, an amine, a ketone, an ether, or a halide. Each R group independently can comprise at least one of a silanol, an alkoxide, or a chloride. An example of a silsesquioxane is octa(dimethylsiloxy) silsesquioxane.

At least one of the R groups can comprise a functional group that can tether the silsesquioxane to the polyimide. As used herein, a tether refers to a molecular chain that is used to connect the polyimide to the silsesquioxane. A tether length, i.e., the atoms linked in a row and located in between, the silsesquioxane and the polymer chain can be 3 to 10 atoms, or 4 to 6 atoms. Prior to tethering, at least one of the R groups can comprise a reactive functional group, for example, an amine or an alcohol that can react with a functional group on the poly(amic acid), for example, a carboxyl group.

The silsesquioxane can be incorporated into the polyimide using a variety of methods. The silsesquioxane can be tethered to a monomer before polymerization of the poly(amic acid). The silsesquioxane can be tethered to the poly(amic acid) after the formation of the poly(amic acid). The silsesquioxane can comprise two or more reactive groups, for example, two or more amine groups and can be reacted with the monomers for incorporation into the backbone of the poly(amic acid) and ultimately into the backbone of the polyimide.

The silsesquioxane can be tethered to a monomer or to the poly(amic acid) via a reactive group on a monomer. For example, the poly(amic acid) can comprise repeat units derived from a monomer (for example, a diamine) comprising one or more, or 1 to 2 attachment groups, for example, carboxylic acid groups. Examples of such monomers include 3,5-diaminobenzoic acid (DBA) and 4,4′-diamino[1,1′-biphenyl]-2,2′-carboxylic acid DBDA as illustrated in formulae II and III, respectively.

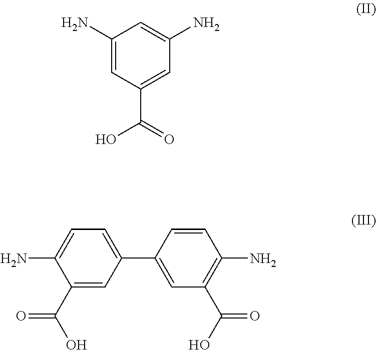 [SMILES: Nc1cc(N)cc(C(=O)O)c1 ; Nc1ccc(-c2ccc(N)c(C(=O)O)c2)cc1C(=O)O]

The silsesquioxane can be reacted with the carboxylic group prior to polymerization. The silsesquioxane can be reacted with the carboxylic group after polymerization of the poly(amic acid). Controlling the relative amount of monomers comprising attachment points can dictate the amount of molecular tethers.

The polyimide can have a CTE in the x- and y-directions of less than or equal to 5 ppm/° C., or less than or equal to 1 ppm/° C., or −0.5 to 0.5 ppm/° C., or −0.1 to 0.1 ppm/° C., as determined in accordance with E831-06 (−125 to 20° C., z-direction film thickness of 1 mil (0.0254 mm), or 0 to 20° C., z-direction film thickness of 1 mil (0.0254 mm)).

The polyimide composition can comprise a fluoropolymer. “Fluoropolymer” as used herein includes homopolymers and copolymers that comprise repeat units derived from a fluorinated alpha-olefin monomer, i.e., an alpha-olefin monomer that includes at least one fluorine atom substituent, and optionally, a non-fluorinated, ethylenically unsaturated monomer reactive with the fluorinated alpha-olefin monomer. Exemplary fluorinated alpha-olefin monomers include CF₂═CF₂, CHF═CF₂, CH₂═CF₂, CHCl═CHF, CClF═CF₂, CCl₂═CF₂, CClF═CClF, CHF═CCl₂, CH₂═CClF, CCl₂═CClF, CF₃CF═CF₂, CF₃CF═CHF, CF₃CH═CF₂, CF₃CH═CH₂, CHF₂CH═CHF, and CF₃CH═CH₂, and perfluoro(C₂₋₈alkyl)vinyl ethers such as perfluoromethyl vinyl ether, perfluoropropyl vinyl ether, and perfluorooctylvinyl ether. The fluorinated alpha-olefin monomer can comprise at least one of tetrafluoroethylene (CF₂═CF₂), chlorotrifluoroethylene (CClF═CF₂), (perfluorobutyl)ethylene, vinylidene fluoride (CH₂═CF₂), or hexafluoropropylene (CF₂═CFCF₃). Exemplary non-fluorinated monoethylenically unsaturated monomers include ethylene, propylene, butene, and ethylenically unsaturated aromatic monomers such as styrene and alpha-methyl-styrene. The fluoropolymer can comprise at least one of poly(chlorotrifluoroethylene) (PCTFE), poly(chlorotrifluoroethylene-propylene), poly(ethylene-tetrafluoroethylene) (ETFE), poly(ethylene-chlorotrifluoroethylene) (ECTFE), poly(hexafluoropropylene), poly(tetrafluoroethylene) (PTFE), poly(tetrafluoroethylene-ethylene-propylene), poly(tetrafluoroethylene-hexafluoropropylene) (also known as fluorinated ethylene-propylene copolymer (FEP)), poly(tetrafluoroethylene-propylene) (also known as fluoroelastomer) (FEPM), poly(tetrafluoroethylene-perfluoropropylene vinyl ether), a copolymer having a tetrafluoroethylene backbone with a fully fluorinated alkoxy side chain (also known as a perfluoroalkoxy polymer (PFA)) (for example, poly(tetrafluoroethylene-perfluoropropylene vinyl ether)), polyvinylfluoride (PVF), polyvinylidene fluoride (PVDF), poly(vinylidene fluoride-chlorotrifluoroethylene), perfluoropolyether, perfluorosulfonic acid, or perfluoropolyoxetane. The fluoropolymer can comprise poly(tetrafluoroethylene).

The fluoropolymer can be in the form of a plurality of particles. The plurality of particles can have an average particle size of less than or equal to 10 or 3 to 8 Average particle size can be determined using dynamic light scattering, for example, measuring an average diameter. Particles that are too large can result in the formation of a surface roughness on cast films and particles that are too small can result in a significant increase in the viscosity of the combination, rendering it more difficult to cast.

The polyimide composition can be formed by forming a combination comprising a poly(amic acid), a fluoropolymer, a solvent, and optionally a nonionic surfactant; casting the combination; and heating the cast combination to evaporate the solvent and imidize the poly(amic acid) to form the polyimide. The combination can comprise 50 to 90 vol %, or 60 to 80 vol % of the solvent based on the total volume of the combination. The solvent can comprise at least one of acetamide, acetone, acetonitrile, dichloromethane, dimethylacetamide, dimethylformamide, dimethylsulfoxide, ethyl acetate, formamide, N-methylformamide, N-methylpyrrolidone, or tetrahydrofuran.

The combination can comprise 0 to 5 weight percent (wt %), or 1 to 4 weight percent of the nonionic surfactant based on the total weight of the combination. The nonionic surfactant can comprise a C₈₋₂₂ aliphatic alcohol ethoxylate having 1 to 25 moles of ethylene oxide and a narrow homolog distribution of the ethylene oxide (“narrow range ethoxylates”) or a broad homolog distribution of the ethylene oxide (“broad range ethoxylates”). The nonionic surfactant can comprise a C₁₀₋₂₀ aliphatic alcohol ethoxylate having 2 to 18 moles of ethylene oxide. Examples of commercially available nonionic surfactants of this type are TERGITOL 15-S-9 (a condensation product of C₁₁₋₁₅ linear secondary alcohol with 9 moles ethylene oxide) and TERGITOL 24-L-NMW (a condensation product of C₁₂₋₁₄ linear primary alcohol with 6 moles of ethylene oxide) with a narrow molecular weight distribution, commercially available from Dow. Other nonionic surfactants that can be used include polyethylene, polypropylene, and polybutylene oxide condensates of C₆₋₁₂ alkyl phenols, for example, compounds having 4 to 25 moles of ethylene oxide per mole of C₆₋₁₂ alkylphenol, or 5 to 18 moles of ethylene oxide per mole of C₆₋₁₂ alkylphenol. Commercially available surfactants of this type include IGEPAL CO-630, TRITON X-45, TRITON X-114, TRITON X-100, TRITON X102, TERGITOL TMN-10, TERGITOL TMN-100X, and TERGITOL TMN-6 (all polyethoxylated 2,6,8-trimethyl-nonylphenols or combinations thereof) from Dow.

The polyimide composition can further comprise at least one of a plurality of hollow microspheres or a ceramic filler. If present, the plurality of hollow microspheres and the ceramic filler can be added to the combination. The hollow microspheres can comprise at least one of ceramic hollow microspheres, polymeric hollow microspheres, or glass hollow microspheres (such as those made of an alkali borosilicate glass). The polyimide composition can comprise 1 to 70 vol %, or 5 to 70 vol %, or 10 to 50 vol % of the hollow microspheres based on the total volume of the polyimide composition. The hollow microspheres can have an average outer diameter of less than or equal to 300 micrometers (μm), or 15 to 200 μm, or 20 to 100 μm, or 20 to 70 μm, or 30 to 65 μm, or 40 to 55 μm, or 35 to 60 μm.

The polyimide composition can comprise a dielectric filler that can be selected to adjust the dielectric constant, dissipation factor, coefficient of thermal expansion, and other properties of the polyimide composition. The dielectric filler can comprise at least one of titanium dioxide (such as rutile and anatase), barium titanate, strontium titanate, silica (including fused amorphous silica), corundum, wollastonite, Ba₂Ti₉O₂₀, solid glass spheres, hollow glass spheres, hollow ceramic spheres, quartz, boron nitride, aluminum nitride, silicon carbide, beryllia, alumina, alumina trihydrate, magnesia, mica, talc, nanoclay, or magnesium hydroxide.

The dielectric filler can be surface treated with a silicon-containing coating, for example, an organofunctional alkoxy silane coupling agent. A zirconate or titanate coupling agent can be used. The coupling agents can improve the dispersion of the filler in the polyimide composition and reduce water absorption of the finished polyimide composition. The polyimide composition can comprise 10 to 80 vol %, or 20 to 60 vol %, or 40 to 60 vol % of the dielectric filler based on the total volume of the polyimide composition.

The polyimide composition can have a CTE in the x- and y-directions of less than or equal to 50 ppm/° C., or less than or equal to 45 ppm/° C., or less than or equal to 25 ppm/° C., or 20 to 42 ppm/° C. As used herein, the x- and y-directions are parallel to a broad surface of a flat layer formed from the polyimide composition and the z-direction is perpendicular to the broad surface. The polyimide composition can have a CTE in the z-direction of less than or equal to 150 ppm/° C., or 70 to 110 ppm/° C., or less than or equal to 75 ppm/° C.

The polyimide composition can have a permittivity (often referred to as the dielectric constant) of less than or equal to 3 at a frequency of 10 GHz.

The polyimide composition can have a dielectric loss (often referred to as the dissipation factor or the loss tangent) of less than or equal to 0.006 at a frequency of 10 GHz. The polyimide composition can have a dielectric loss 0.001 to 0.006, or less than or equal to 0.005 at a frequency of 10 GHz. As used herein the permittivity and dielectric loss can be determined at room temperature, for example, at 23° C.

The polyimide composition can be in the form of a layer. The layer can have a z-direction thickness of less than or equal to 10 millimeters (mm), or 0.1 to 5 mm, or 1 to 3 mm. The layer can have a z-direction thickness of less than or equal to 10 mm, or 0.05 to 5 mm, or 0.05 to 1 mm.

An article can comprise the polyimide composition. The article can be a heat sink, a bond ply, a copper clad laminate, a circuit, or a circuit assembly. The articles are especially useful in electronic devices.

The following examples are merely illustrative and are not intended to limit articles or devices made in accordance with the disclosure to the materials, conditions, or process parameters set forth therein.

### EXAMPLES

The CTE was determined by ASTM D3386-00 over a temperature range of −125° C. to 20° C. using a 1 mil (0.0254 millimeter) thick sample.

The water absorbance was determined by submerging the dried sample in room temperature water for 24 hours, removing the sample, and patting the surface of the sample with a paper towel to remove excess water. The difference in mass after the submergence in reported.

### Examples 1 and 2

Two polyimide compositions were prepared by forming a combination comprise the poly(amic acid) precursor to NOVASTRAT 905 that is commercially available from NeXolve, Huntsville, Ala., a plurality of PTFE particles having an average particle size of 6 μm, TRITON X-100, and DMAC. The combinations comprised 3 weight percent of the TRITON X-100 based on the total weight of the poly(amic acid) precursor and 60 to 80 vol % of the DMAC based on the total volume of the combination. The relative amounts of the poly(amic acid) precursor to the PTFE particles are shown in Table 1 in vol % (vol %). The combinations were cast into films, the solvent was evaporated, and the cast films were heated to 300° C. to form the polyimide. The dielectric and thermal properties were measured and are shown in Table 1.

TABLE 1

| Example | 1 | 2 |
|---|---|---|
| NOVASTRAT 905 (vol %) | 61 | 50 |
| PTFE (vol %) | 39 | 50 |
| Permittivity at 10 GHz | 2.647 | 2.450 |
| Dissipation factor at 10 GHz | 0.00343 | 0.00365 |
| x-, y- CTE (ppm/° C.) | 24 | 41 |
| z- CTE (ppm/° C.) | 74 | 99 |
| Water absorbance (wt % gain) | <5 | <5 |

Set forth below are non-limiting aspects of the present disclosure.

Aspect 1: A polyimide composition comprising: a polyimide having a linear CTE of less than or equal to 1 ppm/° C., or −0.5 to 0.5 ppm/° C. as determined in accordance with ASTM E831-06 or ASTM D3386-00 at −125° C. to 20° C. using a 1 mil (0.0254 millimeter) thick sample; and a fluoropolymer; wherein the polyimide composition has a permittivity of less than or equal to 5, or less than or equal to 3.5 at a frequency of 10 GHz.

Aspect 2: The polyimide composition of Aspect 1, wherein the polyimide is derived from a diamine comprising at least one of p-phenylene diamine or 2,2′-dimethylbenzidine.

Aspect 3: The polyimide composition of any one or more of the preceding aspects, wherein the polyimide is derived from a dianhydride comprising at least one of 3,3′,4,4′-biphenyltetracarboxylic dianhydride or pyromellitic dianhydride.

Aspect 4: The polyimide composition of any one or more of the preceding aspects, further comprising a silsesquioxane.

Aspect 5: The polyimide composition of Aspect 4, wherein the silsesquioxane is tethered to the polyimide.

Aspect 6: The polyimide composition of any one or more of the preceding aspects, wherein the fluoropolymer is in the form of a plurality of particles having an average particle size of less than or equal to 10 μm, or 3 to 8 μm as determined by dynamic light scattering.

Aspect 7: The polyimide composition of any one or more of the preceding aspects, wherein the fluoropolymer comprises at least one of poly(chlorotrifluoroethylene), poly(chlorotrifluoroethylene-propylene), poly(ethylene-tetrafluoroethylene), poly(ethylene-chlorotrifluoroethylene), poly(hexafluoropropylene), poly(tetrafluoroethylene), poly(tetrafluoroethylene-ethylene-propylene), poly(tetrafluoroethylene-hexafluoropropylene), poly(tetrafluoroethylene-propylene), poly(tetrafluoroethylene-perfluoropropylene vinyl ether), a copolymer having a tetrafluoroethylene backbone with a fully fluorinated alkoxy side chain, polyvinylfluoride, polyvinylidene fluoride, poly(vinylidene fluoride-chlorotrifluoroethylene), perfluoropolyether, perfluorosulfonic acid, or perfluoropolyoxetane.

Aspect 8: The polyimide composition of any one or more of the preceding aspects, wherein the fluoropolymer comprises poly(tetrafluoroethylene).

Aspect 9: The polyimide composition of any one or more of the preceding aspects, wherein the polyimide composition comprises 40 to 80 vol %, or 40 to 70 vol % of the polyimide based on the total volume of the polyimide and the fluoropolymer or based on the total volume of the polyimide composition.

Aspect 10: The polyimide composition of any one or more of the preceding aspects, wherein the polyimide composition comprises 20 to 60 vol %, or 30 to 60 vol % of the fluoropolymer based on the total volume of the polyimide and the fluoropolymer or based on the total volume of the polyimide composition.

Aspect 11: The polyimide composition of any one or more of the preceding aspects, further comprising at least one of a plurality of hollow microspheres or a ceramic filler.

Aspect 12: The polyimide composition of any one or more of the preceding aspects, wherein the polyimide composition comprises 0 weight percent of a glass fabric.

Aspect 13: The polyimide composition of any one or more of the preceding aspects, wherein the polyimide composition has at least one of: a CTE in the x- and y-directions of less than or equal to 50, or less than or equal to 45 ppm/° C., or less than or equal to 25 ppm/° C., or 20 to 42 ppm/° C., as determined in accordance with ASTM D3386-00; a CTE in the z-direction of less than or equal to 150 ppm/° C., or 70 to 110 ppm/° C., or less than or equal to 75 ppm/° C., as determined in accordance with ASTM D3386-00; or a dielectric loss of less than or equal to 0.006 at a frequency of 10 GHz. Preferably, the polyimide composition has a dielectric loss of less than or equal to 0.006, or 0.001 to 0.006, or less than or equal to 0.005 at a frequency of 10 GHz.

Aspect 14: A method of making the polyimide composition of any one or more of the preceding aspects comprising: forming a combination comprising a poly(amic acid), the fluoropolymer, a solvent, and optionally a nonionic surfactant; casting the combination; heating the cast combination to evaporate the solvent and to form the polyimide from the poly(amic acid).

Aspect 15: The method of Aspect 14, wherein the solvent comprises at least one of acetamide, acetone, acetonitrile, dichloromethane, dimethylacetamide, dimethylformamide, dimethylsulfoxide, ethyl acetate, formamide, N-methylformamide, N-methylpyrrolidone, or tetrahydrofuran.

Aspect 16: The method of any one or more of Aspects 14 to 15, wherein the combination comprises 50 to 90 vol %, or 60 to 80 vol % of the solvent based on the total volume of the combination.

Aspect 17: The method of any one or more of Aspects 14 to 16, wherein the combination comprises 0 to 5 weight percent, or 1 to 4 weight percent of the nonionic surfactant based on the total weight of the combination.

Aspect 18: An article comprising the polyimide composition of any one or more of the preceding aspects.

Aspect 19: The article of Aspect 18, wherein the polyimide composition is in the form of a layer.

Aspect 20: The article of Aspect 19, wherein the layer has a thickness of less than or equal to 10 mm, or 0.1 to 5 mm, or 1 to 3 mm.

Aspect 21: The article of Aspect 19, wherein the layer has a thickness of less than or equal to 10 mm, or 0.05 to 5 mm, or 0.05 to 1 mm.

Aspect 22: An electronic device comprising the article of Aspects 18 to 21.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced item. The term “or” means “and/or” unless clearly indicated otherwise by context. Reference throughout the specification to “an aspect”, “another aspect”, “some aspects”, and so forth, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects. “Combination” is inclusive of mixtures, solutions, alloys, and the like.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A polyimide composition comprising:
a polyimide having a linear coefficient of thermal expansion of less than or equal to 1 parts per million per degree Celsius as determined in accordance with ASTM E831-06 at −125 to 20 degrees Celsius using a 1 mil (0.0254 millimeter) thick sample; and
a fluoropolymer;
wherein the polyimide composition has a permittivity of less than or equal to 5 at a frequency of 10 gigahertz.

2. The polyimide composition of claim 1, wherein the polyimide is derived from a diamine comprising at least one of p-phenylene diamine or 2,2′-dimethylbenzidine.

3. The polyimide composition of claim 1, wherein the polyimide is derived from a dianhydride comprising at least one of 3,3′,4,4′-biphenyltetracarboxylic dianhydride or pyromellitic dianhydride.

4. The polyimide composition of claim 1, further comprising a silsesquioxane.

5. The polyimide composition of claim 4, wherein the silsesquioxane is tethered to the polyimide.

6. The polyimide composition of claim 1, wherein the fluoropolymer is in the form of a plurality of particles having an average particle size of less than or equal to 10 micrometers, as determined by dynamic light scattering.

7. The polyimide composition of claim 1, wherein the fluoropolymer comprises at least one of poly(chlorotrifluoroethylene), poly(chlorotrifluoroethylene-propylene), poly(ethylene-tetrafluoroethylene), poly(ethylene-chlorotrifluoroethylene), poly(hexafluoropropylene), poly(tetrafluoroethylene), poly(tetrafluoroethylene-ethylene-propylene), poly(tetrafluoroethylene-hexafluoropropylene), poly(tetrafluoroethylene-propylene), poly(tetrafluoroethylene-perfluoropropylene vinyl ether), a copolymer having a tetrafluoroethylene backbone with a fully fluorinated alkoxy side chain, polyvinylfluoride, polyvinylidene fluoride, poly(vinylidene fluoride-chlorotrifluoroethylene), perfluoropolyether, perfluorosulfonic acid, or perfluoropolyoxetane.

8. The polyimide composition of claim 1, wherein the fluoropolymer comprises poly(tetrafluoroethylene).

9. The polyimide composition of claim 1, wherein the polyimide composition comprises 40 to 80 volume percent of the polyimide based on the total volume of the polyimide and the fluoropolymer.

10. The polyimide composition of claim 1, wherein the polyimide composition comprises 20 to 60 volume percent of the fluoropolymer based on the total volume of the polyimide and the fluoropolymer.

11. The polyimide composition of claim 1, further comprising at least one of a plurality of hollow microspheres or a ceramic filler.

12. The polyimide composition of any one or more of the preceding claims, wherein the polyimide composition comprises 0 weight percent of a glass fabric.

13. The polyimide composition of claim 1, wherein the polyimide composition has at least one of:
a coefficient of thermal expansion in the x- and y-directions of less than or equal to 50 parts per million per degree Celsius as determined in accordance with ASTM D3386-00;
a coefficient of thermal expansion in the z-direction of less than or equal to 150 parts per million per degree Celsius as determined in accordance with ASTM D3386-00; or
a dielectric loss of less than or equal to 0.006 at a frequency of 10 gigahertz.

14. A method of making the polyimide composition of claim 1 comprising:
forming a combination comprising a poly(amic acid), the fluoropolymer, a solvent, and optionally a nonionic surfactant;
casting the combination; and
heating the cast combination to evaporate the solvent and to form the polyimide from the poly(amic acid).

15. The method of claim 14, wherein the solvent comprises at least one of acetamide, acetone, acetonitrile, dichloromethane, dimethylacetamide, dimethylformamide, dimethylsulfoxide, ethyl acetate, formamide, N-methylformamide, N-methylpyrrolidone, or tetrahydrofuran.

16. The method of claim 14, wherein the combination comprises 50 to 90 volume percent of the solvent based on the total volume of the combination.

17. The method of claim 14, wherein the combination comprises 0 to 5 weight percent of the nonionic surfactant based on the total weight of the combination.

18. An article comprising the polyimide composition of claim 1.

19. The article of claim 18, wherein the polyimide composition is in the form of a layer.

20. The article of claim 19, wherein the layer has a thickness of less than or equal to 10 millimeters.
